(19) United States
(12) Patent Application Publication
(10) Pub. No.: US 2026/0195812 A1
(43) Pub. Date: Jul. 9, 2026

(54) DIFFERENTIATING INTEGRATED QUALITY ASSURANCE SIMULATOR FRAMEWORK

(71) Applicant: Synchrony Bank, Stamford, CT (US)

(72) Inventors: Deepak Padalia, Stamford, CT (US); Anji Babu Pathuri, Stamford, CT (US); Vish Dadireddy, Stamford, CT (US); Ashok Uppalapati, Stamford, CT (US); Poornachandra Takkalapally, Stamford, CT (US); Seamus Sullivan, Stamford, CT (US)

(21) Appl. No.: 19/202,178

(22) Filed: May 8, 2025

Related U.S. Application Data
(60) Provisional application No. 63/743,374, filed on Jan. 9, 2025.

(51) Int. Cl. G06Q 40/03; G06N 20/00

(52) U.S. Cl. CPC G06Q 40/03; G06N 20/00

(57) ABSTRACT

A method may include determining to use a simulated response of a service to a parameter value. Determining does not include running the service to generate a real-time response. The method may include searching a database for the parameter value. The database may include a mapping of responses and parameter values. The method may also include retrieving the simulated response mapped to the parameter value. The method may further include receiving one or more other responses from one or more other services. Additionally, the method may include outputting a result using the simulated response and the one or more other responses. Embodiments may include associated computer-readable storage medium, computing systems, and other systems.

### CROSS REFERENCE TO RELATED APPLICATION

This application claims the benefit of priority to U.S. Provisional Patent Application No. 63/743,374, filed Jan. 9, 2025, entitled “DIFFERENTIATING INTEGRATED QUALITY ASSURANCE SIMULATOR FRAMEWORK”, the entire contents of which are incorporated herein by reference for all purposes.

### BACKGROUND

In the modern financial ecosystem, financial services companies play a pivotal role in providing consumers with access to critical services, such as credit line increases, loan approvals, and other financial transactions. These services, however, are rarely performed in isolation. Instead, they depend on a wide array of interdependent services, many of which are operated by third parties, including partner institutions, merchants, or external service providers. These external entities often provide data or perform auxiliary processes that inform decision-making in the primary financial service.

For instance, when a financial services company evaluates a request for a credit line increase, it may rely on external credit bureaus to provide credit scores, merchants to supply transaction data, or fraud prevention systems to ensure secure processing. Similarly, loan approvals often require verification of employment or income, which may involve interactions with payroll processors or tax authorities. Each of these interactions necessitates communication with external systems, often in real-time, to obtain the necessary data or approval signals.

However, constant communication with these third-party systems presents significant challenges. These include increased latency due to network delays, higher operational costs associated with processing multiple requests, and potential risks related to data security and system availability. Additionally, financial services companies may encounter compatibility issues when integrating with diverse external systems, as well as difficulties in maintaining consistent service-level agreements (SLAs) across different partners.

Embodiments of the present invention allow financial services companies and other companies to effectively perform functions without constant reliance on external services, while still maintaining accuracy, compliance, and security.

### BRIEF SUMMARY

Embodiments described herein may allow for faster, more computationally efficient, and cheaper development of applications. Embodiments may use simulated responses from services in place of real-time responses from services. The simulated responses may be developed through machine learning. Additionally, the decision whether to use simulated responses may also be determined through machine learning.

In embodiments, a method includes determining to use a simulated response of a service to a parameter value. Determining does not include running the service to generate a real-time response. The method may include searching a database for the parameter value. The database may include a mapping of responses and parameter values. The method may also include retrieving the simulated response mapped to the parameter value. The method may further include receiving one or more other responses from one or more other services. Additionally, the method may include outputting a result using the simulated response and the one or more other responses.

Embodiments may include associated computer-readable storage medium, computing systems, and other systems.

### TERMS AND DEFINITIONS

“About” or “approximately” can mean within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Alternatively, particularly with respect to biological systems or processes, the term “about” or “approximately” can mean within an order of magnitude, within 5-fold, and more preferably within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%.

“Machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

“Cutoff” or “threshold” refers to predetermined numbers used in an operation. For example, a threshold value may be a value above or below which a particular classification applies. Either of these terms can be used in either of these contexts. A cutoff or threshold may be “a reference value” or derived from a reference value that is representative of a particular classification or discriminates between two or more classifications. A cutoff may be chosen after and based on output of the test data. For example, certain cutoffs may be used for a certain statistical significance. A reference value can be selected as representative of one classification (e.g., a mean) or a value that is between two clusters of the metrics (e.g., chosen to obtain a desired sensitivity and specificity). As another example, a reference value can be determined based on statistical simulations of samples. Any of these terms can be used in any of these contexts. Such a reference value can be determined in various ways, as will be appreciated by the skilled person. For example, metrics can be determined for two different sets of data with different known classifications, and a reference value can be selected as representative of one classification (e.g., a mean) or a value that is between two clusters of the metrics (e.g., chosen to obtain a desired sensitivity and specificity). As another example, a reference value can be determined based on statistical simulations of samples. A particular value for a cutoff, threshold, reference, etc. can be determined based on a desired accuracy (e.g., a sensitivity and specificity).

### BRIEF DESCRIPTION OF THE DRAWINGS

To easily identify the discussion of any particular element or act, the most significant digit or digits in a reference number refer to the figure number in which that element is first introduced.

FIG. 1 illustrates a flow for using a simulated response according to embodiments of the present invention.

FIG. 2 illustrates a simulation process according to embodiments of the present invention.

FIG. 3 illustrates an example of a user interface according to embodiments of the present invention.

FIG. 4 illustrates a financing option page according to embodiments of the present invention.

FIG. 5 illustrates a loan application page according to embodiments of the present invention.

FIG. 6 illustrates a user interface according to embodiments of the present invention.

FIG. 7 illustrates a stub according to embodiments of the present invention.

FIG. 8 is a flowchart of a method according to embodiments of the present invention.

FIG. 9 illustrates analyzing data with machine learning models according to embodiments of the present invention.

FIG. 10 illustrates a computing system according to embodiments of the present invention.

### DETAILED DESCRIPTION

As the technology landscape becomes more dependent on application programming interfaces (APIs), microservices, and other services, developing or testing an application may rely on having these interdependent services available. A given application developed or run by one entity may call APIs and other services developed or run by other entities (including, e.g., merchants or partners). These APIs and other services may not be available (e.g., scheduled or unscheduled downtime) or may be in their own stage of development or testing. Accordingly, developing or testing software may be delayed by coordination around services not under the main developer's control.

The framework described herein allows simulating a real service response to serve users whenever downstream systems are under development, unresponsive, or down, allowing integration with merchants and partners. Embodiments described herein may allow stakeholders to generate responses/outputs on the fly in a self-service fashion. Coordination between various upstream and downstream systems may not be needed.

Embodiments allow teams to view, search, edit, and/or remove virtual services in a decoupled fashion without impacting other services. Embodiments facilitate rapid development in helping ship a prototype or a quality assured product within a specified time.

Benefits include improved speed to market. Embodiments aid the development team and quality team to shorten the development cycle by reducing the dependencies on the external or third party services over which the team does not have control.

Embodiments described herein reduce complexity. The framework can decrease the number of downstream systems and different integration scenarios being used in an application. Embodiments may include excluding downstream systems or not requiring a network connection with the downstream systems. In some embodiments, connections with the downstream systems may be temporarily or permanently deactivated or deprioritized. Other connectivity may be prioritized, thereby creating a more robust overall system.

Embodiments can enhance collaboration. The collaboration between customers and a product team may increase as a result of simulated services, which can be used in lieu of real services. Embodiments avoid waiting for real service availability.

The framework described herein can improve performance and load tests. The real systems may not be used to test large loads. The large loads for testing may negatively impact systems in production. Simulated services may allow for large loads to be tested against certain parts of an application while not impacting other services. Performance of the application can be improved based on results of these simulated large loads.

Embodiments described herein may improve automation. The framework can be used to perform quality assurance automation field validation/integration testing.

Embodiments provide for self service development or quality assurance or other testing. The framework needs little technical/coding experience. Anyone on the team can create the simulated service by using an internal graphical user interface administrator application. The mapping of responses to parameter values reduces or eliminates the need for coding simulated responses.

Embodiments may include role-based access control (RBAC), which works on least privilege principle. Each user has just enough permissions to perform a task. Embodiments increase security of testing environments by restricting user access to systems being simulated or the existing codebase, as most or all customization of a process may be performed through a graphical user interface.

Embodiments allow for auditing. For each simulated service, auditing is supported as the change history is maintained.

Embodiments allow for scenario simulation. The simulated services can be linked together to create a group or scenario ideal for end-to-end processes.

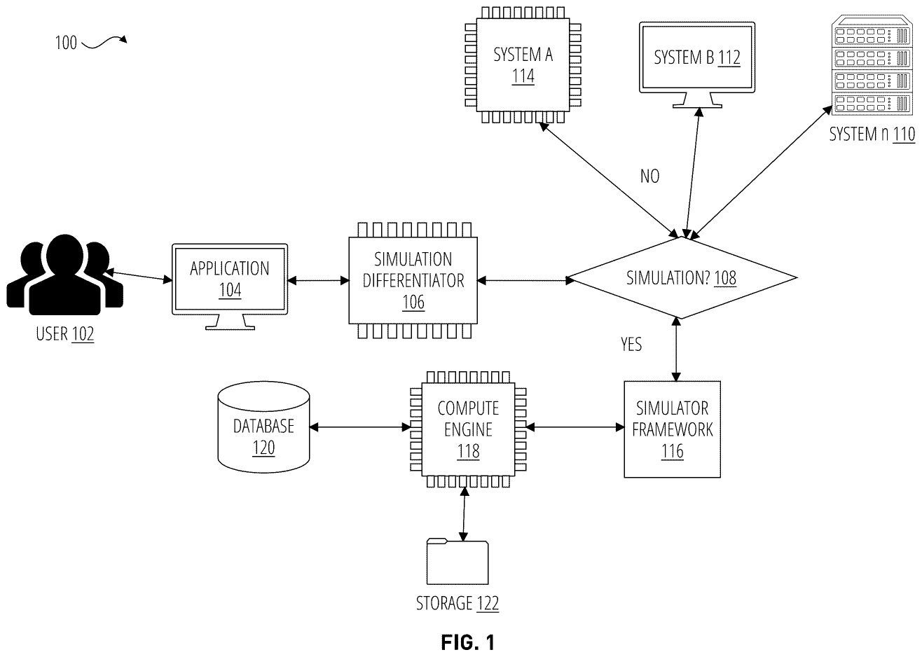

FIG. 1 shows an end-to-end flow 100 for using a simulated response. User 102 may interact with application 104. Application 104 may be a front-end application. For example, application 104 may be based on an application that a customer or a merchant uses. However, application 104 may be modified such that it can be used for product development or quality assurance. As an example, application 104 may be software during development. In embodiments, user 102 may be a software developer or a quality engineer. In some embodiments, user 102 may be a software development team or a quality team.

A simulation differentiator 106 may intercept communications from application 104. Simulation differentiator 106 may determine whether to simulate a service. In some embodiments, the decision on whether to simulate a service may be determined by user 102, including through application 104. User 102 may set a flag in the interface of application 104 indicating that a certain service is to be simulated. In some embodiments, simulation differentiator 106 may determine that a certain service is to be simulated. In some embodiments, simulation differentiator 106 may have information that a certain system associated with a service is offline or undergoing maintenance, and as a result, that service may be simulated. In some embodiments, simulation differentiator 106 may determine that for certain types of applications, certain services may be simulated. For example, applications involving health and wellness may be tested based on a certain population at a given point in time. Simulation differentiator 106 may then determine that services that call for updated dated can be simulated rather than run. In some embodiments, simulation differentiator 106 may determine that for a set of inputs entered into application 104, certain services have little or no impact on a result. Those services can then be simulated.

In some embodiments, simulation differentiator 106 may be a machine learning model configured to determine which services should be simulated. A machine learning model may be trained using training data sets having different values for parameters. The machine learning model may be configured to determine what parameter values have little impact on an output given sets of other parameter values. When a certain set of parameter values is input into the simulation differentiator 106, the machine learning model may then determine that certain services may be simulated because a subset of those parameters have a small impact on the output. In some embodiments, the machine learning model may determine that a simulated service provides acceptable accuracy when compared to running the service. Learning algorithms may be used to suggest rules based on the historical analysis of simulated responses. Scenario-based responses may be created. The suggestions may be based on the request/response bodies, header parameters, response codes, query parameters, or other parameters.

In some embodiments, simulation differentiator 106 may consider the computational cost or the financial cost of running a service. A service may require a payment for running the service. Running a service may incur a computational cost—e.g., a cost of waiting for the service to run. These costs may be determined by simulation differentiator 106 or provided to simulation differentiator 106. The simulation differentiator 106 may also consider the cost of not running the service. The simulation differentiator 106 may predict the possible error given when simulating the service compared to running the service. This possible error may be from past runs of the application. In some embodiments, a machine learning model may predict the error. The error may be converted to a cost (e.g., a computational cost or a financial cost). For example, the financial cost may be missing on the opportunity to provide a customer a loan or providing a customer a loan who will not be able to repay the loan. The computational cost may be the cost of re-running the application with running the service instead of simulating the service. The machine learning model may be trained with training datasets having labels of the error or cost associated with simulating a service. The training datasets may include sets of parameter values. The machine learning model may optimize the services (e.g., how many, which ones) to simulate to achieve an error or a cost under a threshold.

User 102 may decide to simulate certain service or services. A machine learning model may verify that such a simulation does not incur a cost above a threshold. If the cost is above a threshold, the simulation differentiator 106 may prompt the user to confirm the simulation. The machine learning model may also evaluate if additional services can be simulated without impacting cost above a threshold. The simulation differentiator 106 may prompt user 102 on whether additional services should be simulated.

Decision block 108 shows the paths depending on whether or not simulation is used. If there is no simulation, then communications may be sent to different systems (e.g., system A 114, system B 112, and/or system n 110). These systems may be third-party systems. The systems process information provided by application 104. The systems provide outputs that are returned to application 104.

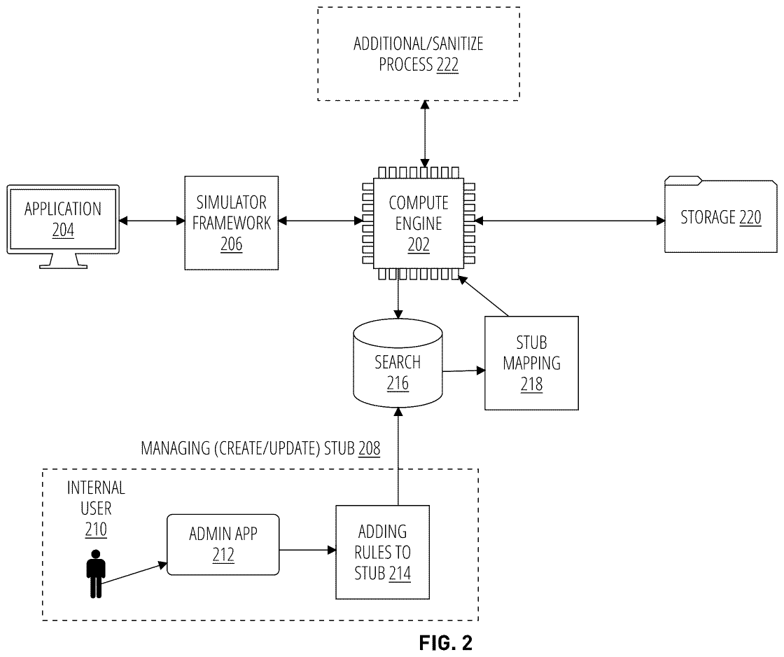

If simulation is used, then information from application 104 goes to simulator framework 116. Simulator framework 116 passes on the request for a simulation to compute engine 118. Compute engine 118 may be a computing device, including a server. Compute engine 118 queries database 120 for a response related to parameter value(s) specified by application 104. Database 120 returns a reference identification associated with the parameter value(s). Compute engine 118 then retrieves a response associated with the reference identification from storage 122. Simulator framework 116, compute engine 118, database 120, and storage 122 are described in more detail in FIG. 2.

Even if decision block 108 results in simulation, one or more of system A 114, system B 112, and system n 110 may still be communicated with to generate a response to be used with the response from simulator framework 116.

FIG. 2 shows the simulation process, particularly around compute engine 202, in more detail. Application 204 may be the same or similar as application 104. Assuming a simulated result will be used, information, which may include parameter values, may be sent to simulator framework 206, which may be the same or similar as simulator framework 116. Parameter values may be values filled out in application 204 by a user or values related to metadata (e.g., geographic location, timestamp) when completing or submitting a form in application 204. Simulator framework 206 may pass the parameter values to compute engine 202. Compute engine 202 may be the same or similar as compute engine 118.

Compute engine 202 searches for a response to provide to application 204 based on the parameter values. At some point before application 204 is run, managing (create/update) stub 208 is performed. A stub is a response. In managing (create/update) stub 208, internal user 210 may execute an administrator application 212. Administrator application 212 may be available to only certain types of users. These users may be users in a software development group or a quality group. The users may be working on updating application 204. Application 204 may be in development, or certain modules under application 204 may be in development. Administrator application 212 may include an interface that allows for internal user 210 to add or update rules to the stub 214.

Adding rules to stub 214 may include setting conditional statements for types of responses (stubs) based on certain values of input parameters. Internal user 210 may access administrator application 212 to create, update, and/or delete rules to stub 214. Internal user 210 may set these and other rules. As an example, if application 204 is a loan application, internal user 210 may set a rule that a certain minimum net worth results in a loan approval. In this embodiment, the stub is a response indicating whether a loan is approved, and the rule is that a minimum net worth results in a loan approval. The stub may include additional rules governing whether a loan is approved or rejected.

In some embodiments, a machine learning model may determine rules. The machine learning model may be trained to determine common responses when provided certain values of input parameters. The machine learning model may be trained with a dataset including sets of input parameters and labels indicating the response. The machine learning model may have hyperparameters optimized so that the machine learning model outputs the response when the input parameters are fed into the machine learning model.

In some embodiments, the machine learning model may aid internal user 210 in determining rules. The machine learning model may be trained using the rules created by internal user 210. The training dataset may include the rules labeled with the response. The machine learning model may have hyperparameters optimized so that the machine learning model outputs the response given a certain rule. The machine learning model may generate a list of new rules and responses.

Compute engine 202 may receive from application 204 values for different parameter values. A parameter value may include a flag indicating that a service is to be simulated. Compute engine 202 may determine the parameters needed for the simulation of the service. Compute engine 202 may then search database 216 for a response/stub associated with the input parameter values and/or the service to be simulated. Database 216 may include the various rules created or updated by internal user 210 or by a machine learning model. Database 216 may point to a stub mapping 218, which maps a response to the input parameter values. The stub mapping 218 may be an index number or a reference ID number for a response document.

Compute engine 202 may receive the index number or reference ID number and retrieve the associated document/response from storage 220. Storage 220 may be the same or similar as storage 122. Storage 220 may store responses in the form of JSON (JavaScript Object Notation), XML (Extensible Markup Language), or other types of files. The response may be sent from compute engine 202 to simulator framework 206. The response may be combined with responses from services not simulated or other simulated services. Post-processing may occur after retrieving the document/response. For example, the post-processing may provide calculated dynamic values in the simulated response. In some embodiments, static information may be pulled from persistence storage as required by the simulated response. In some embodiments, the response may be sent for an additional/sanitize process 222. The response may be sanitized to remove personally identifiable information (PII) or other sensitive information. In some embodiments, additional/sanitize process 222 may include extensions or modifiers. The response after the additional/sanitize process 222 may be sent back to compute engine 202, which may then send the sanitized or modified response to simulator framework 206 and then to application 204.

In some embodiments, the response may be an output when provided the values of the input parameters. For example, application 204 may be a loan approval application. A certain threshold income level or net worth entered into application 204 may result in an automatic approval. In some embodiments, combinations of parameter values may result in an automatic approval (e.g., threshold income level with maximum debt level). The rule for the stub may be to return a loan approval response based on the values of the input parameters. For example, the rule may be to return a loan approval message. The message may also include details (e.g., name, address) in addition to the message of approval. The message or template for the message may be saved in storage 220 and retrieved based on stub mapping 218. Application 204 may be able to test and run additional services (e.g., fraud alerts, software checks), even though the simulated response is approval. One or more of these additional services may overrule the simulated response. For example, a fraud alert may require additional verification of the customer, which would at least pause the loan approval. Hence, application 204 can test other services without running a service to check the credit worthiness of a particular customer.

In some embodiments, the response may be an intermediate output, which may be used by another service. For example, application 204 may be a loan approval application. The simulated service may be a credit score service. The credit score may be used along with another service (e.g., employment verification, home address verification) to determine whether a loan application is approved. Instead of communicating with a credit bureau to determine a customer's score, the credit score may be simulated. The credit score may be simulated by a machine learning model or by statistical analysis based on values of input parameters. The rule in adding rules to stub 214 may be the machine learning model, the statistical analysis, or a mathematical relationship. In embodiments, the stub mapping 218 may link to a particular document in storage 220 with the particular credit score. In some embodiments, stub mapping 218 may link to a template document in storage 220 and include instructions for filling out the template document. For example, stub mapping 218 may include retrieving a template document, which is a comma delimited file for different credit scores, and may include instructions to populate the template document with credit scores of “700”, “720”, and “740”.

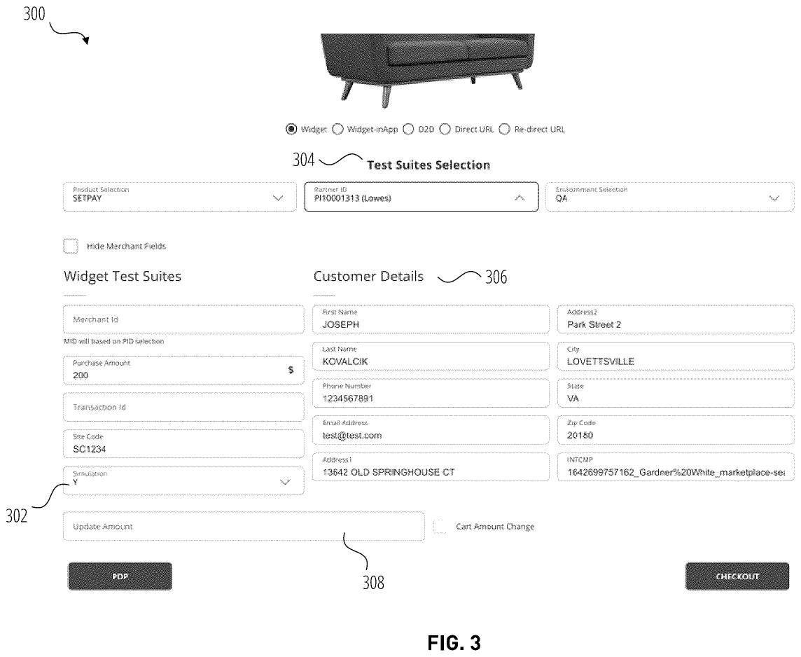

FIG. 3 shows an example of a user interface 300. User interface 300 may be application 204 or may include parts of application 204. With FIG. 3, the example application is an application to see whether a customer can qualify for a loan or “pay later” program. However, user interface 300 replaces the typical customer view with some customized fields. User interface 300 may set parameters for a simulation and/or prepopulate fields that ordinarily would be filled out by the customer. As an example, flag 302 may indicate whether or not a simulated response should be used.

User interface 300 may include test parameters. For example, test suites selection 304 may allow for selection of certain product types, partners, and test environments (e.g., development, quality assurance).

User interface 300 may include fields that are normally shown to a customer, including customer details 306. As examples, these fields may include customer name, address, email address, telephone number, and other details.

User interface 300 may include product details 308, which may include the product type, price, and/or quantity. As the user interface 300 may be in a test environment, the user may have the ability to modify product details 308.

In some embodiments, some of these inputs may be used by the simulation differentiator. Flag 302 may indicate to the simulation differentiator that a service should be simulated. In some embodiments, other features (including customer details 306, product details 308) may be used by a machine learning model to determine if services should be simulated. The values user interface 300 may be sent to the simulation differentiator and/or the machine learning model. In some embodiments, the simulation differentiator may update fields in user interface 300 to indicate that certain services are recommended to be simulated.

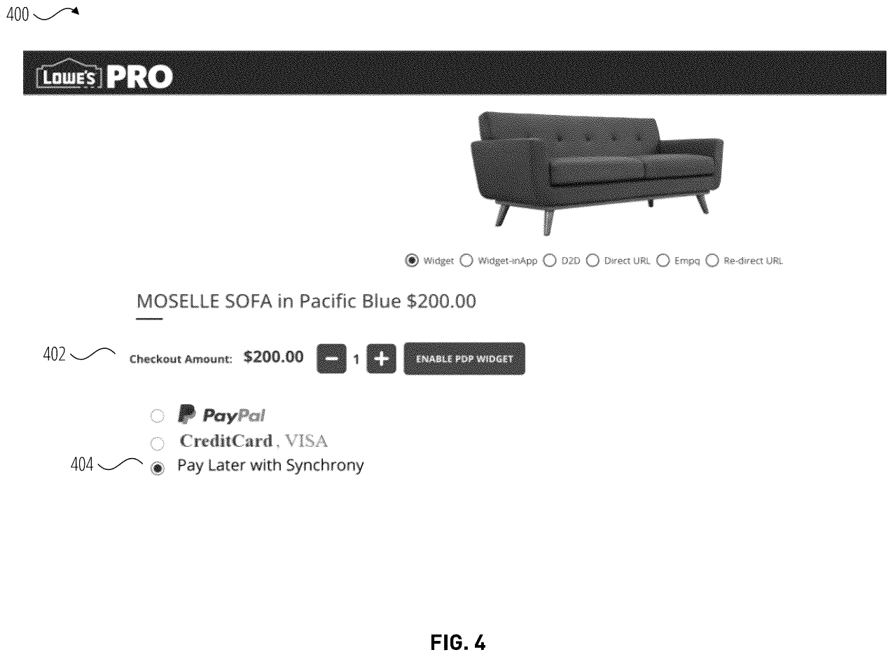

FIG. 4 shows financing option page 400. Financing option page 400 may be a page that is displayed after a customer chooses a checkout option. Financing option page 400 may show price 402, which may have been specified in product details 308 in FIG. 3. Financing option page 400 may be displayed after user interface 300 is submitted. Pay later option 404 is selected, which may be prepopulated based on fields filled out by the user in user interface 300. In production, the financing option page 400 may be the page that the customer uses to initiate the application being developed with simulated services. In some embodiments, user interface 300 may include all relevant inputs, so that financing option page 400 may not be displayed.

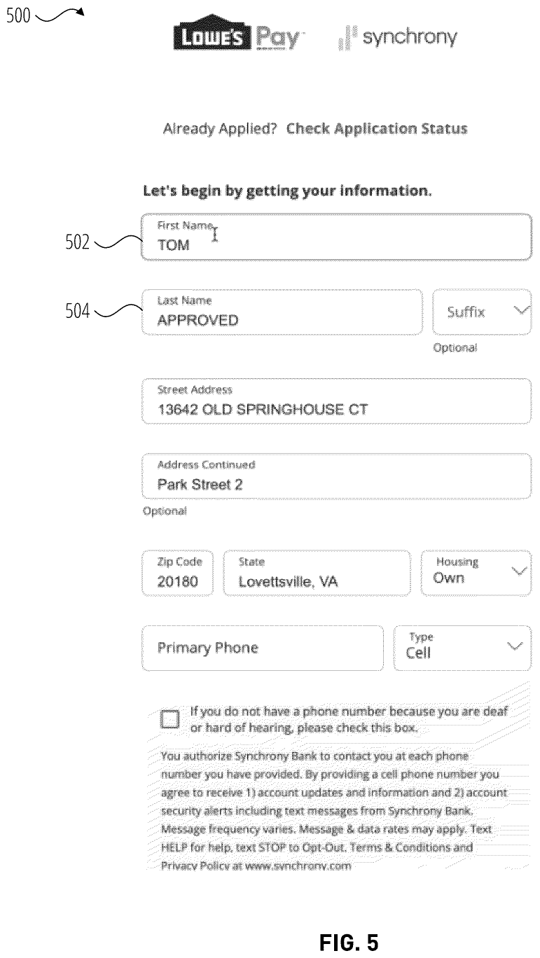

FIG. 5 shows a loan application page 500. Loan application page 500 may be a page that a customer interacts with and fills out to apply for a loan. The various fields in loan application page 500 may be pre-populated with information provided in customer details 306 of user interface 300.

The user may submit the loan application using loan application page 500. In a final production version of loan application page 500, the loan application page 500 may initiate communication with several systems. For example, the systems may include a credit bureau system, a financial institution system, a criminal background check system, a fraud alert system, a computing device security verification system, or other system. In embodiments described herein, one or more of the systems may be simulated. FIG. 3, FIG. 4, and/or FIG. 5 may be considered to be application 104 or application 204. In some embodiments, user interface 300 may include all relevant inputs, so that loan application page 500 may not be displayed.

### Example 1

An example is described in view of FIG. 3, FIG. 4, and FIG. 5. A user may want to test an application to see if the application can determine the loan payment parameters of a “pay later” program when proceeding through an online checkout process. The loan approval portion of the application is less important. As a result, the user may create a stub (e.g., managing (create/update) stub 208) that associates an approval response with a fictitious name of “Tom Approved.” The stub may indicate that document ID ABC should be the response when the name “Tom Approved” is used.

In an interface similar to user interface 300, the user may fill out customer details 306 and product details 308. The customer details 306 may include a first name of “Tom” and a last name of “Approved.” The user may also set flag 302 to indicate that simulated results should be used. The user may submit the form.

The user may then proceed with financing option page 400, which may be the page that the customer uses to initiate the application being developed or tested by the user. The user, acting in the role of the customer, may choose “Pay Later with Synchrony.” Certain fields such as price 402 and pay later option 404 may be pre-populated based on entries in user interface 300.

Submission of the financing option page 400 may lead to loan application page 500. Loan application page 500 may include customer details. Loan application page 500 may be prepopulated with information entered in user interface 300. In some embodiments, the user may fill out loan application page 500. Loan application page 500 may include “Tom” as first name 502 and “Approved” as last name 504.

Submission of loan application page 500 may then be routed toward a simulation differentiator 106. Simulation differentiator 106 may determine that flag 302 is selected for simulation. The information from loan application page 500 may then be sent to simulator framework (e.g., simulator framework 116 or simulator framework 206).

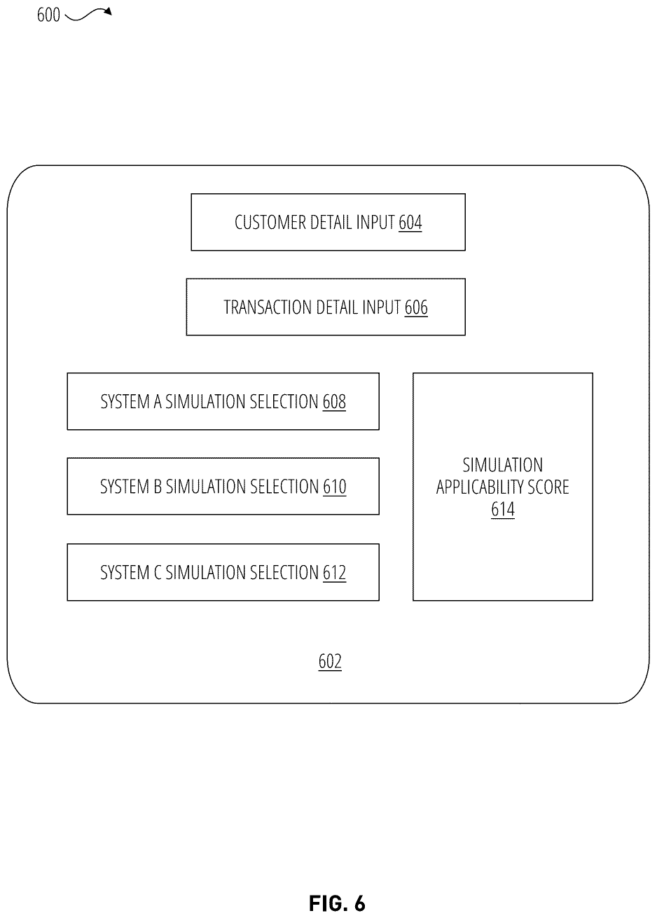

Compute engine (e.g., compute engine 118 or compute engine 202) may then determine the simulated response for the entries in loan application page 500. In some embodiments, the user may set a flag for the specific service to simulate. For example, the user may indicate that the loan approval service should be simulated. The compute engine may search a database for responses associated with one or more fields in loan application page 500. In some embodiments, all the fields may be used. In some embodiments, the user may designate the specific fields to be searched. In some embodiments, the compute engine may use a machine learning model to select the fields to be searched based on historical choices or those that are expected to have a certain amount (e.g., most or least) of impact on the application. A user interface may be updated to emphasize or de-emphasize the fields (as described in more detail with FIG. 6).

Upon a search of a database, the compute engine may determine that first name 502 of “Tom” and last name 504 of “Approved” is mapped to document ID ABC. The compute engine may then retrieve document ID ABC from storage (e.g., storage 122 or storage 220). Document ID ABC may be a response that states that the loan is approved. Document ID ABC may be specific computer code or instructions for the application to indicate the loan is approved.

Mappings related to fields other than first name 502 and last name 504 may be used. For example, a certain minimum income or savings may result in loan approval. In the event that two different mappings result in two different documents, the compute engine may determine which document, if any, to use as a simulated response. The compute engine may prompt the user to select a response. The compute engine may use a machine learning model to determine the appropriate response. The machine learning model may be trained using historical user feedback when faced with similar response choices.

While the loan approval may be simulated, other systems may not be simulated. For example, systems to set up and track loan payments and schedules, systems to verify security of the computing device, systems to authenticate the customer, and other systems may still be executed.

### Example 2

An application may involve health and wellness. For example, a payment card may be issued for a health and wellness client, where the payment card can only be used for certain categories of expenses. The application may allow for the reimbursement of the expenses and following up on the status of a reimbursement request. In production, the application may access a service providing a history of health and wellness transactions. For the development of the application, the application does not need to keep querying the service for up-to-date list of transactions. Instead, a simulated response may include a snapshot of health and wellness transactions at a certain time. In this manner, the application may be tested on a dataset that does not change, and the same dataset can be reused for other scenarios and/or applications, leading to more efficient troubleshooting and software development. In some embodiments, the user interface may dynamically update to hide display of health and wellness transactions after a certain time, improving the user interface by avoiding unneeded information.

An internal user 210 creates a rule such that generates a simulated response of health and wellness transactions when a certain application is tested or certain flag in the application is checked. The simulated response of health and wellness transactions also may be a smaller response (e.g., smaller list of transactions, smaller list of customers) than what would be generated in production. This saves on processing time and improves computational efficiency.

### Example 3

A user may want to develop an application to determine whether a customer is a candidate for a credit line increase. The application, when run in production, may call upon different systems, including an outstanding debt system, a fraud alert system, a bank account system, and an employment verification system. The test application therefore uses responses from the outstanding debt system, the fraud alert system, the bank account system, and the employment verification system. In this example, creating and updating a stub/response may be through a machine learning model rather than an internal user 210.

The application may be tested by calling the four listed systems for different sets of input parameters. The responses from these four systems are then input into the application and a result is generated. These test runs of the application therefore create a dataset including sets of input parameters, associated responses from the four systems, and a final result. This dataset can be input into a model. A machine learning model may be trained on this dataset to recognize systems that have little influence on the final result given certain input parameters. A machine learning model may also be trained on the dataset to recognize that certain systems have only limited sets/ranges of responses. A machine learning model may also be trained to determine certain input values of parameters are likely to lead to certain responses. In this example, the machine learning model may recognize that the fraud alert system may generate a binary response—either a fraud alert is present or is absent. The machine learning model may also determine from the dataset a strong correlation between certain input parameters (such as amount of bank account activity) and the presence of a fraud alert.

With a new test of the application, the machine learning model may recommend to the user that the fraud alert system be simulated rather than run. The user may accept the recommendation. The machine learning model may then simulate the response of the fraud alert system. The outstanding debt system, the bank account system, and the employment verification system may be run and responses generated. Those responses and the simulated response may be used by the application to output a result. In this example, the fraud alert system is not run, increasing computational efficiency by avoiding waiting for another system to run and return a result.

FIG. 6 shows a user interface 600 to assist with running simulated responses. User interface 600 may be similar to or include any elements from user interface 300, financing option page 400, or loan application page 500. User interface 600 may be part of application 104 or application 204.

User interface 600 includes a window 602 for configuring a system to output a result using a simulated response. Window 602 may include fields for customer detail input 604 and/or transaction detail input 606. Customer detail input 604 may include any customer details 306. Transaction detail input 606 may include information regarding a transaction, including, for example, payment, interest rate (e.g., APR), term, or financing options.

Window 602 may also include fields or icons for selecting simulation of different systems. As examples, window 602 includes options for system A simulation selection 608, system B simulation selection 610, and system C simulation selection 612. These selections may allow setting of a flag, such as flag 302, which indicates whether the associated system should be simulated.

Window 602 may also display simulation applicability score 614. The simulation applicability score 614 may be a score indicating how much each system is a candidate for simulation. For example, a higher score may indicate that a system can be simulated without affecting the results. The simulation applicability score 614 may be determined through a machine learning model that processes customer detail inputs 604 and/or transaction detail inputs 606 to determine which systems can be simulated without significant impact on results.

User interface 600 may be rearranged according to the applicability of the simulation to the customer detail input 604 and/or transaction detail input 606. A user selection may be received to organize the system simulation selection fields or icons based on the applicability scores. The applicability scores can be determined as described above. The selection fields or icons can be moved automatically so that the ones with the highest applicability scores are position in the window 602 closest to the customer detail input 604, transaction detail input 606, or a button to proceed with next steps in performing testing. In some embodiments, the selection fields or icons may be emphasized or de-emphasized instead of being rearranged. For example, selection fields or icons with high applicability scores may be bolded, enlarged, or highlighted with a particular color. Selection fields or icons with low applicability scores (e.g., under a cutoff) may be hidden. In some embodiments, the emphasizing or de-emphasizing may occur dynamically in real time as inputs are entered.

In some embodiments, user interface 600 may display a summary of simulated systems, where the particular system or results from the simulated system are selectable by a user to run the system rather than simulate. The results may then be updated to use the results from running the system rather than simulate the system.

In some embodiments, user interface 600 may display a summary of systems that are not simulated. The particular system or results from the system may be selectable by a user to simulate the system rather than run the system. The results may then be updated to sue the results from simulating the system rather than running the system.

The user interface 600 is improved, allowing for the user to more efficiently select systems to simulate. The user can identify systems to simulate more quickly. The user interface 600 may be more compact, not needing to show all possible systems for simulation. The user interface 600 is improved, allowing for the user to test whether systems should be simulated or run. Furthermore, the overall method is improved by allowing testing to occur more efficiently with simulated systems.

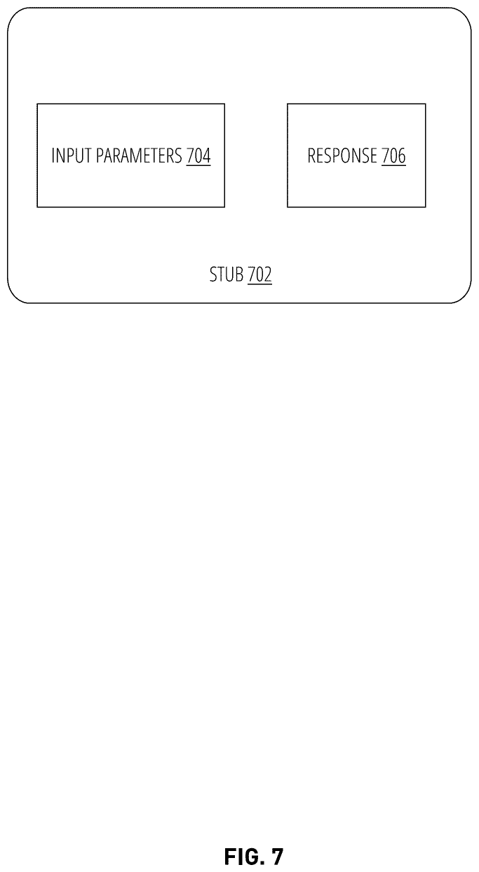

FIG. 7 shows an illustration of a stub 702. Stub 702 may be a rule that involves one or more input parameters 704. The input parameters 704 may be customer details, transaction details, merchant details, or any parameters described herein. Stub 702 may include a response 706 associated with the input parameters 704. The response 706 may include a number and/or text. For example, the response 706 can be a notice indicating approval of a loan or the financial details (monthly payments, interest rate, term). The stub 702 may be a correspondence of certain responses to certain input parameters. In some embodiments, stub 702 may include a model (e.g., statistical model or machine learning model) to determine the response for certain input parameters.

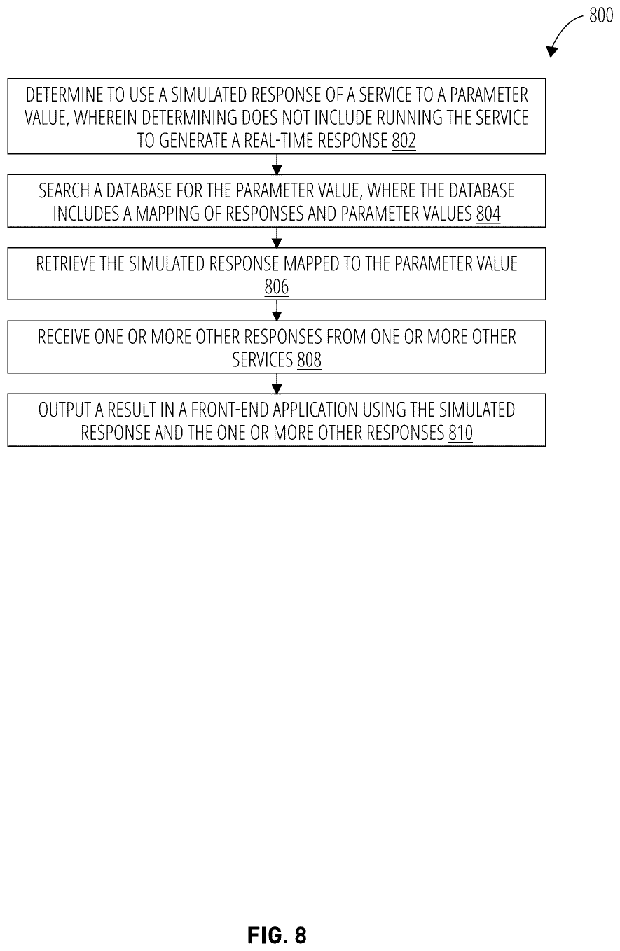

FIG. 8 shows a method 800 of outputting a result using a simulated response. FIG. 8 may be performed by any computing system described herein, including simulation differentiator 106, compute engine 118, compute engines 202, and computer system 1000.

In block 802, method 800 determines to use a simulated response of a service to a parameter value. Determining may not include running the service to generate a real-time response. The service may include a security service, a fraud detection service, a credit score service, a loan approval service, or a health and wellness service. These services may process details of a customer and/or transaction and return an output. The processing may be according to particular rules. For example, the fraud detection service may process information regarding a customer to determine if there are any fraud alerts. The security service may provide an output of whether the customer device, merchant system, and/or point-of-sale system is secure (e.g., is running valid copy of the latest software, does not have viruses). The fraud detection service may provide an output of whether the customer has a fraud alert or if the transaction likely is fraudulent. The credit score service may return a credit score for a customer. The loan approval service may determine the creditworthiness of a customer or approve a customer for a loan. The health and wellness service may determine whether a transaction is a qualified health and wellness expense or provide a health improvement plan. The service may include an application programming interface (API), a middleware service, or an internal microservice. Determining to use the simulated response may include determining a value of a flag set by a user. For example, the flag may be a checkbox to select running the simulated response.

Determining to use the simulated response may include determining the service is offline. The service may be determined to be offline from accessing a communication regarding a planned outage. The service may be determined to be offline from a failed attempt to run the service.

In embodiments, determining to use the simulated response may include using an algorithm to determine an importance of a response from a service on a result. The algorithm may include a machine learning model configured to generate an importance of the response on the result. The algorithm may analyze results from previous runs of the application. Statistical methods to determine the importance of a response include correlation analysis, regression analysis (linear, logistic, ridge, lasso, multivariate), ANOVA, machine learning feature importance (tree-based models, SHAP values, permutation importance), hypothesis testing (t-tests, chi-square, Wilcoxon), sensitivity analysis, principal component analysis (PCA), partial dependence plots (PDP), and variance inflation factor (VIF). If a response has under a threshold importance, method 800 may suggest/determine using a simulated response. The importance may be analyzed for certain sets of parameter values. For example, a service may generate responses that are important to a result for a random set of parameter values. However, given certain set(s) of parameter values, the importance may be low. The algorithm may compare the current test parameter value(s) with the certain set(s) of parameter values that result in low importance of the service response. Given enough similarity between the current test parameter value(s) with the certain set(s) of parameter values, the algorithm may determine or suggest a simulated response.

In embodiments, particular responses may be associated with particular input values of parameters. A machine learning model may identify a pattern from a previous response. The previous response may be from previous tests of an application, using real-time responses from services. The machine learning model may continue to train and/or fine-tune based on responses from running services and results using responses. A machine learning model may generate a simulated response for particular input values of parameters using previous response from running the service. For example, a machine learning model may identify a pattern where input values for parameters A, B, C are x, y, and z lead to a specific response. The machine learning model may generate the simulated response using the specific response.

In embodiments, an algorithm, including a machine learning model, may recognize that a response for a service is limited to set of responses. The algorithm may analyze or be trained from previous tests of the application or previous real-time responses from running services. The algorithm may generate a distribution of responses. In some embodiments, the algorithm may determine that the computational load of re-running the application for each of the possible responses is less than the computational load of running the service. The algorithm may recommend to the user that the application be run for all possible simulated responses for the service. In some embodiments, the algorithm may determine the distribution of responses from running a service. The algorithm may analyze the distribution to determine the spread of the distribution or the modal result of the distribution. If the spread of the distribution is below a threshold or the modal result has a high enough frequency, method 800 may suggest a simulated response instead of running a service.

Method 800 may include dynamically updating an interface based on an algorithm and/or machine learning model determining/suggesting a simulated response. The interface may be updated by checking an option to include a simulated response for a service. The interface may be user interface 300, user interface 600, or any interface described here.

In block 804, method 800 searches a database for the parameter value. The database may include a mapping of responses and parameter values. The mapping may be determined from one or more rules. The one or more rules may be generated by a user or by an algorithm. In some embodiments, the mapping may be performed by an algorithm, including a machine learning model. As an example, the machine learning model may generate the simulated response and create a mapping for the simulated response to the input values for the parameters. The parameters may include request/response bodies, header parameters, response codes, query parameters, customer details, transaction details, or any parameters described herein. The machine learning model may be trained using data from past runs of the application and/or service. The method may include associating the responses to the parameter values to generate the mapping. In some embodiments, the machine learning model may process parameter values and the responses to generate the mapping.

Method 800 may include displaying to a user an interface to modify rules for mapping the response to the parameter values. In some embodiments, method 800 may include dynamically updating the interface with mappings determined by an algorithm or machine learning model.

In block 806, method 800 retrieves the simulated response mapped to the parameter value. Retrieving the simulated response may be from a storage repository storing a plurality of simulated responses.

In block 808, method 800 receives one or more other responses from one or more other services. The one or more other services may be third-party services or internal services (controlled by same entity developing the application).

In block 810, method 800 outputs a result using the simulated response and the one or more other responses. The result may be an indication of a status of a customer (e.g., qualified, unqualified, approved, unapproved). The result may be financial details of a product (e.g., interest rate, payments, loan term, fees).

Method 800 may further include analyzing the result. Method 800 may include updating an application using the result. The application may be configured to run the service and the one or more services to generate an application result. The application may be a front-end application.

In some embodiments, the results may be analyzed by a machine learning model. The results may be processed through the machine learning model, which may be trained on past results using past simulated responses. The machine learning model may assess whether the current results significantly deviate from past results. If a significant deviation is found, the machine learning model may notify the user. The machine learning model may automatically re-run a test with running one or more services that were previously simulated. The new result may be analyzed and used to fine-tune the machine learning model, so that the machine learning model can better recommend services to be simulated. Computational time and resources may be saved with the updated machine learning model by avoiding test runs that may with unrealistic or anomalous results.

Method 800 may receive feedback from the user. The feedback may be on the simulated response or the result. For example, the feedback may be on the quality/acceptability of the simulated response or result. The user may provide feedback that the simulated response is unrealistic or not accurate. The user may provide feedback that the results are not accurate. The user may be provided an option to provide a rating score for the simulated response and/or the results. The user may determine that a system should be run instead of simulated because of anomalous results, which may not be captured by a machine learning algorithm.

Method 800 may update the simulated response based on the feedback. Method 800 may involve updating the mapping of the simulated responses to parameter values. For example, method 800 may associate a different simulated response to the parameter values or a different set of parameter values to the simulated response. In some embodiments, method 800 may involve generating a new simulated response based on the feedback. A machine learning model may be fine-tuned so as to reject the previous simulated response and generate a new mapping of a replacement simulated response to the parameter value(s). The fine-tuning may involve adjusting hyperparameters or weights of the machine learning model.

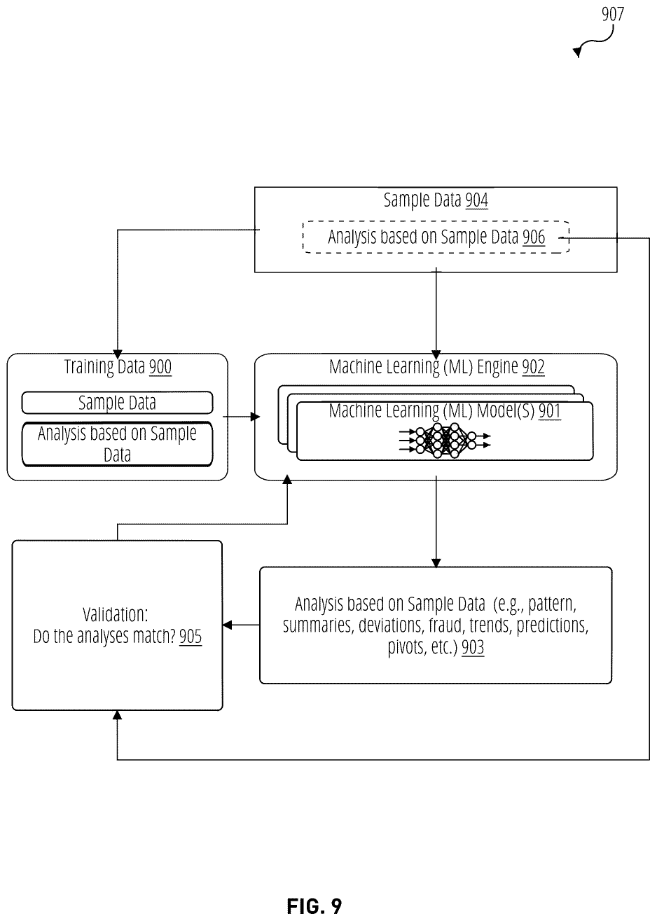

FIG. 9 is a block diagram illustrating using one or more machine learning models 901 of a machine learning engine 902 to analyze data to recognize a pattern. The ML engine 902 generates, trains, and uses the ML model(s) 901 based using training data 900. The ML engine 902 trains the ML model(s) 901 to generate an analysis 903 on input of sample data 904 into the ML model(s) 901. The sample data 904 may include data that is extracted from the data stores (e.g., a system that performs the method 800; database 120; a data store accessible by application 104, a data store accessible by system A 114, system B 112, system n 110; a data store accessible by simulation differentiator 106; a data store accessible by compute engine 118; storage 122; a data store accessible by application 204; a data store accessible by administrator application 212;). In some examples, the sample data 904 may include data that is normalized, merged, and/or processed following extraction (e.g., by any of the systems listed above). In some examples, the sample data 904 may include allocation option results, participant history, and/or modifications (e.g., by any of the systems listed above). In some examples, the sample data 904 may include some preliminary validation data and/or analysis data, such as summary data (e.g., by any of the systems listed above).

The analysis 903 output by the ML model(s) 901 can include at least one pattern identified as part of the analysis 903 of the sample data 904. The pattern can include any type of patterns, for instance including patterns associated with high or low success ratios by participants, types of transactions or merchants favored for methods described herein, and/or types of users frequently requesting allocation options. In some examples, the analysis 903 output by the ML model(s) 901 can include various other elements of analyses described with method 800.

The training data that the ML engine 902 uses to train the ML model(s) 901 includes sample data (e.g., akin to the sample data 904) as well as pre-generated assessment(s) corresponding to the sample data (e.g., akin to the analysis 903 corresponding to the sample data 904). Over the course of the initial training with training data 900, the ML model(s) 901 develop hidden layers between input layers and output layers, and/or weights and/or connections between nodes of the various layers, that each relate to various aspects of the analysis 903, such as any of the aspects described herein (e.g., related to various types of patterns that can be detected and characteristics of those types of patterns).

Once the one or more ML models 901 identify the analysis 903, the analysis 903 (and/or the indication of eligibility of the user account for the modification) can be output to a user (e.g., using a speaker or headphones) and/or to a recipient device that can process and/or put into effect the modification to the client account, for instance by opening a new line or modifying an existing line.

In some examples, the ML engine 902 can continue to train and/or update the ML model(s) 901 over time, for instance based on validation 905 using the analysis 903 and the sample data 904. In some examples, an analysis 906 of the sample data 904 (separate from the analysis 903 generated by the ML model(s) 901) may be provided to the ML engine 902 use in performing the validation 905. In some examples, the analysis 906 may be generated by a different entity than the ML model(s) 901, for instance a different set of ML model(s) (not pictured) or one or more trusted human analysts. If, during validation 905, the ML engine 902 determines that the analysis 903 generated by the ML model(s) 901 matches the analysis 906, the ML engine 902 can treat this as positive feedback, and can perform further training of the ML model(s) 901 based on the analysis 903, the sample data 904, and/or the analysis 906, for instance to strengthen and/or reinforce weights associated with generating the analysis 903 in the ML model(s) 901, and/or to weaken or remove other weights other than those associated with generating the analysis 903, in the ML model(s) 901. If, during validation 905, the ML engine 902 determines that the analysis 903 generated by the ML model(s) 901 differs from the analysis 906, the ML engine 902 can treat this as negative feedback, and can perform further training of the ML model(s) 901 based on the analysis 903, the sample data 904, and/or the analysis 906, for instance to weaken and/or remove weights associated with generating the analysis 903 in the ML model(s) 901, and/or to strengthen and/or reinforce other weights other than those associated with generating the analysis 903 in the ML model(s) 901.

In some examples, the ML engine 902 receives feedback during validation 905 about the analysis 903. The feedback can include a reaction by a user of a user device via a user interface, a reaction by a user determined based on sensor data from a user device, and/or decisions by a user and/or user device as whether or not to use the analysis 903 for a further application. Positive feedback can be used to strengthen and/or reinforce weights associated with generating the analysis 903 in the ML model(s) 901, and/or to weaken or remove other weights other than those associated with generating the analysis 903 in the ML model(s) 901. Negative feedback can be used to weaken and/or remove weights associated with generating the analysis 903 in the ML model(s) 901, and/or to strengthen and/or reinforce other weights other than those associated with generating the analysis 903 in the ML model(s) 901.

The ML engine 902 and/or the ML model(s) 901 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 9, a graphic representing the trained ML model(s) 901 is illustrated as a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 902 and/or the ML model(s) 901 can be part of any AI and/or ML modules, processes, or analysis operations discussed herein.

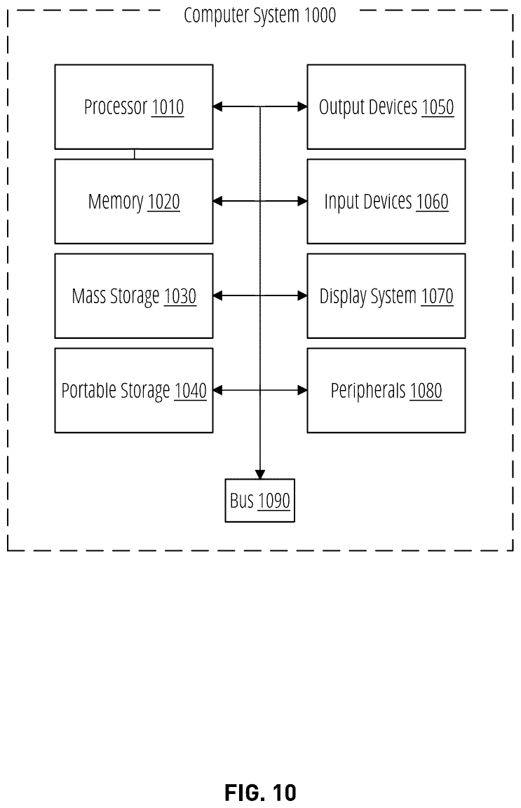

FIG. 10 illustrates an exemplary computing system 1000 that may be used to implement some aspects of the technology. For example, any of the computing devices, computing systems, network devices, network systems, servers, and/or arrangements of circuitry described herein may include at least one computing system 1000, or may include at least one component of the computer system 1000 identified in FIG. 10. The computing system 1000 of FIG. 10 includes one or more processors 1010 and memory 1020. Each of the processor(s) 1010 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 1010 may include one or more cores, either integrated onto a single chip or spread across multiple chips connected or coupled together. Memory 1020 stores, in part, instructions and data for execution by processor 1010. Memory 1020 can store the executable code when in operation. The computing system 1000 of FIG. 10 further includes a mass storage device 1030, portable storage device(s) 1040 (e.g., drive(s) and/or other storage media), output devices 1050, user input devices 1060, a display system 1070 (e.g., graphics display), and peripheral device(s) 1080.

The components shown in FIG. 10 are depicted as being connected via a single bus 1090. However, the components may be connected through one or more data transport means. For example, processor 1010 and memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor 1010. Mass storage device 1030 can store the system software for implementing some aspects of the subject technology for purposes of loading that software into memory 1020.

Portable storage device 1040 operates in conjunction with a portable non-volatile storage medium, such as a floppy disk, compact disk or digital video disc, to input and output data and code to and from the computer system 1000 of FIG. 10. The system software for implementing aspects of the subject technology may be stored on such a portable medium and input to the computer system 1000 via the portable storage device 1040.

The memory 1020, mass storage device 1030, or portable storage device 1040 may in some cases store sensitive information, such as transaction information, health information, or cryptographic keys, and may in some cases encrypt or decrypt such information with the aid of the processor 1010. The memory 1020, mass storage device 1030, or portable storage device 1040 may in some cases store, at least in part, instructions, executable code, or other data for execution or processing by the processor 1010.

Output devices 1050 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 1070. The printer may be inkjet, laserjet, thermal, or some combination thereof. In some cases, the output device 1050 (and/or associated circuitry) may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 1050 may include any ports, plugs, antennae, wired or wireless transmitters, wired or wireless transceivers, or any other components necessary for or usable to implement the communication types listed above, such as cellular Subscriber Identity Module (SIM) cards.

Input devices 1060 may include circuitry providing a portion of a user interface. Input devices 1060 may include an alpha-numeric keypad, such as a keyboard, for inputting alpha-numeric and other information, or a pointing device, such as a mouse, a trackball, stylus, or cursor direction keys. Input devices 1060 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 1060 may include any ports, plugs, antennae, wired or wireless receivers, wired or wireless transceivers, or any other components necessary for or usable to implement the communication types listed above, such as cellular SIM cards.

Input devices 1060 may include receivers or transceivers used for positioning of the computing system 1000 as well. These may include any of the wired or wireless signal receivers or transceivers. For example, a location of the computing system 1000 can be determined based on signal strength of signals as received at the computing system 1000 from three cellular network towers, a process known as cellular triangulation. Fewer than three cellular network towers can also be used—even one can be used—though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 1000 such as a router, modem, switch, hub, bridge, gateway, or repeater. These may also include Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 1060 may include receivers or transceivers corresponding to one or more of these GNSS systems.

Display system 1070 may include a liquid crystal display (LCD), a plasma display, an organic light-emitting diode (OLED) display, a low-temperature poly-silicon (LTPO) display, an electronic ink or “e-paper” display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripheral device(s) 1080 may include any type of computer support device to add additional functionality to the computer system. For example, peripheral device(s) 1080 may include one or more additional output devices of any of the types discussed with respect to output device 1050, one or more additional input devices of any of the types discussed with respect to input device 1060, one or more additional display systems of any of the types discussed with respect to display system 1070, one or more memories or mass storage devices or portable storage devices of any of the types discussed with respect to memory 1020 or mass storage device 1030 or portable storage device 1040, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 1000 of FIG. 10 can include those typically found in computer systems that may be suitable for use with some aspects of the subject technology and represent a broad category of such computer components that are well known in the art. That said, the computer system 1000 of FIG. 10 can be customized and specialized for the purposes discussed herein and to carry out the various operations discussed herein, with specialized hardware components, specialized arrangements of hardware components, and/or specialized software. Thus, the computer system 1000 of FIG. 10 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 1000 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNU®, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 1000 may also use a Basic Input/Output System (BIOS) or Unified Extensible Firmware Interface (UEFI) as a layer upon which the operating system(s) are run.

In some cases, the computer system 1000 may be part of a multi-computer system that uses multiple computer systems 1000, each for one or more specific tasks or purposes. For example, the multi-computer system may include multiple computer systems 1000 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 1000 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 1020, the mass storage device 1030, the portable storage device 1040, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L7), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 1010 for execution. A bus 1090 carries the data to system RAM or another memory 1020, from which a processor 1010 retrieves and executes the instructions. The instructions received by system RAM or another memory 1020 can optionally be stored on a fixed disk (mass storage device 1030/portable storage device 1040) either before or after execution by processor 1010. Various forms of storage may likewise be implemented as well as the necessary network interfaces and network topologies to implement the same.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order that is logically possible. Additionally, portions of these steps may be used with portions of other steps from other methods. Also, all or portions of a step may be optional. Additionally, any of the steps of any of the methods can be performed with modules, units, circuits, or other means of a system for performing these steps.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The above description of example embodiments of the present disclosure has been presented for the purposes of illustration and description and are set forth so as to provide those of ordinary skill in the art with a complete disclosure and description of how to make and use embodiments of the present disclosure. It is not intended to be exhaustive or to limit the disclosure to the precise form described nor are they intended to represent that the experiments are all or the only experiments performed. Although the disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the disclosure being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within embodiments of the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

All patents, patent applications, publications, and descriptions mentioned herein are hereby incorporated by reference in their entirety for all purposes as if each individual publication or patent were specifically and individually indicated to be incorporated by reference and are incorporated herein by reference to disclose and describe the methods and/or materials in connection with which the publications are cited. None is admitted to be prior art.

What is claimed is:

1. A method comprising:
determining to use a simulated response of a service to a parameter value, wherein determining does not include running the service to generate a real-time response;
searching a database for the parameter value, wherein the database includes a mapping of responses and parameter values;
retrieving the simulated response mapped to the parameter value;
receiving one or more other responses from one or more other services; and
outputting a result using the simulated response and the one or more other responses.

2. The method of claim 1, wherein the mapping is determined from one or more rules.

3. The method of claim 1, wherein the mapping of responses to parameter values is performed by a machine learning model.

4. The method of claim 1, further comprising:
updating a machine learning model configured to map responses to parameter values, wherein updating the machine learning model uses feedback regarding the result.

5. The method of claim 1, wherein determining to use the simulated response includes using a machine learning model configured to generate an importance of a response on the result.

6. The method of claim 1, wherein determining to use a simulated response of a service includes associating particular responses with particular input values of parameters.

7. The method of claim 1, wherein determining to use a simulated response of a service includes generating the simulated response using a previous response from running the service with particular input values of parameters.

8. The method of claim 1, further comprising:
associating the responses to the parameter values to generate the mapping.

9. The method of claim 1, wherein retrieving the simulated response is from a storage repository.

10. The method of claim 1, further comprising:
analyzing the result, and
updating an application using the result, wherein the application is configured to run the service and the one or more other services to generate an application result.

11. The method of claim 1, wherein determining to use the simulated response includes determining the service is offline.

12. The method of claim 1, wherein determining to use the simulated response includes determining a value of a flag set by a user.

13. The method of claim 1, wherein the service includes a security service, a fraud detection service, a credit score service, a loan approval service, or a health and wellness service.

14. The method of claim 1, wherein the service includes an application programming interface (API), a middleware service, or an internal microservice.

15. The method of claim 1, further comprising:
displaying to a user an interface to modify rules for mapping the response to the parameter values.

16. A non-transitory computer-readable storage medium, the computer-readable storage medium including instructions that when executed by a computer, cause the computer to perform a method including:
determining to use a simulated response of a service to a parameter value, wherein determining does not include running the service to generate a real-time response;
searching a database for the parameter value, wherein the database includes a mapping of responses and parameter values;
retrieving the simulated response mapped to the parameter value;
receiving one or more other responses from one or more other services; and
outputting a result using the simulated response and the one or more other responses.

17. The non-transitory computer-readable storage medium of claim 16, wherein the method further includes:
updating a machine learning model configured to map responses to parameter values, wherein updating the machine learning model uses feedback regarding the result.

18. The non-transitory computer-readable storage medium of claim 16, wherein determining to use the simulated response includes using a machine learning model configured to generate an importance of a response on the result.

19. A computing system comprising:
a processor; and
a memory storing instructions that, when executed by the processor, configure the computing system to perform a method including:
determining to use a simulated response of a service to a parameter value, wherein determining does not include running the service to generate a real-time response;
searching a database for the parameter value, wherein the database includes a mapping of responses and parameter values;
retrieving the simulated response mapped to the parameter value;
receiving one or more other responses from one or more other services; and
outputting a result using the simulated response and the one or more other responses.

20. The computing system of claim 19, further comprising:
a compute engine including the processor and the memory;
a simulator framework configured to instruct the compute engine to retrieve a simulated response mapped to the parameter value;
a stub updating module configured to update rules for the mapping; and
the database configured to receive updates from the stub updating module.
